(19) United States
(12) Patent Application Publication
(10) Pub. No.: US 2005/0116615 A1
(43) Pub. Date: Jun. 2, 2005

(54) Light emissive display device

(76) Inventors: Shoichiro Matsumoto, Ogaki-shi (JP); Kazunobu Mameno, Kita-ku (JP)

Correspondence Address: CANTOR COLBURN, LLP, 55 GRIFFIN ROAD SOUTH, BLOOMFIELD, CT, 06002, US

(21) Appl. No.: 10/953,974

(22) Filed: Sep. 29, 2004

(30) Foreign Application Priority Data
Sep. 30, 2003 (JP) 2003-342468
Sep. 17, 2004 (JP) 2004-272635
Sep. 17, 2004 (JP) 2004-272636

(51) Int. Cl. H01J 1/62; H01J 63/04

(52) U.S. Cl. 313/500

(57) ABSTRACT

In a display device using, for example, an organic EL element as a light emissive element, a single pixel is formed of subpixels of four colors, R, G, B, and W, arranged in two rows and two columns. Each pixel is substantially quadrangular in shape, and at least one of the subpixels in the pixel has an area different from the areas of the other subpixels. The subpixels of the colors horizontally adjoining in the same row have the same height, and the subpixels of the colors vertically adjoining in the same column have the same width. Even when the area ratio of the subpixels is varied by changing the position of the intersecting point of divisional lines dividing a pixel into four subpixels, the design can easily be modified by satisfying the above relationship, and a display device with a high luminance and a long life can easily be obtained with any area ratio.

### CROSS-REFERENCE TO RELATED APPLICATIONS

The priority Japanese Patent Applications, Numbers 2003-342468, 2004-272635 and 2004-272636, upon which this patent application is based are hereby incorporated by reference.

### BACKGROUND OF THE INVENTION

1. Field of the Invention

The present invention relates to light emissive display devices having a light emissive element, such as an electroluminescence (EL) element, and, more particularly, to a light emissive display device in which each pixel includes a plurality of subpixels corresponding to different colors.

2. Description of the Related Art

Much attention is focused on self-emissive display devices, such as EL display devices using an organic EL element, as next-generation flat display devices (flat panel displays) and potential replacements for liquid crystal display devices. A typical EL light emissive display device includes a plurality of pixels, each including an EL element, arranged, for example, in a matrix, controlling light emission from each pixel to display a desired image as a whole. For a display presenting full color images, a technique of providing a pixel composed of a plurality of subpixels emitting a plurality of different colors is known as a method of displaying full color by each pixel. In order to realize the emission of light of a different color from each subpixel, in each subpixel a light emissive layer of the EL element maybe formed of a light emissive material for emitting light of a color different from each other, or filters of different colors may be used for the subpixels, while using the same light emissive material for each EL element.

In such an EL display device, each of the R, G, and B subpixels must desirably emit light at a high luminance in order to display an image with a higher white component, such as an image of a natural setting. Although an image can be displayed with a high luminance by increasing the amount of supplied current because light emission intensity of the EL element depends on the amount of current supplied to each EL element, increasing the amount of current not only elevates power consumption in the EL element, but also tends to shorten the life of the display device. This is partially because, with many currently developed organic light emissive materials, the luminance half-life of an EL element tends to be inversely related to the amount of supplied current, i.e. the amount of current flowing through the element, that is, more specifically, the amount of current per unit area (current density).

In view of the above, there have been attempts to extend element life by varying the area of each of the R, G, and B subpixels in accordance with light emission efficiency, such as that disclosed in, for example, Japanese Patent Laid-Open Publication No. 2001-290441.

Another technique for improving element life now being studies is based on a structure utilizing a pixel of four-color configuration in which a white (W) subpixel is provided in addition to the subpixels for three colors, i.e. R, G, and B, to suppress the amount of current per pixel and achieve light emission at a high luminance.

Here, in the pixel having four subpixels of R, G, B, and W, white can be displayed by the W subpixel in principle, thereby eliminating the need for high luminance light emission by all subpixels to display white, and resulting in reduction of the total amount of current per pixel.

However, such a four-color configuration including white in addition to the conventionally known three-color configuration of R, G, and B increases the number of subpixels to be designed. Further, simply comparing such a configuration with the three-color configuration having the same per-pixel area, an effective display (light emissive) region within a pixel, i.e. the aperture ratio of a single pixel, must be decreased because the area of a single pixel is divided into four subpixel areas, and the number of elements and wiring lines to operate each subpixel must be increased at least for the additionally provided subpixel in each pixel. Organic EL elements emit light at a luminance in accordance with the supplied current amount, and therefore current density in the EL element must be increased when the light emissive area for achieving a certain luminance is reduced, leading to a shorter element life.

Accordingly, design of a pixel with a four-color configuration requires a emphasis on maximizing the aperture ratio of each subpixel than does design of a pixel with a three-color configuration.

Further, in a full color display, the white light itself cannot be directly substituted by the R light, G light, or B S light, and therefore the optimum area ratio of a W subpixel to R, G, and B subpixels cannot simply be determined, even when the light emission efficiency is equal for each color. In practice, the light emission efficiency (the efficiency based on the amount of light emitted outside: external quantum efficiency) differs among R, G, and B. It is expected that the W area ratio may need to be adjusted in accordance with the type of image to be displayed, the use or size of the display, and the like.

Thus, when the four-color configuration of R, G, B, and W is employed, numerous factors must be considered to design each pixel layout, and the area ratio may considerably vary, thereby greatly increasing the burden of pixel layout designing. On the other hand, it is desirable to both reduce manufacturing costs by curtailing a development period per type of display devices, and achieve a highly reliable device. It is therefore important to facilitate design of the pixel layout.

### SUMMARY OF THE INVENTION

The present invention facilitates design of a light emissive display device including a pixel having a plurality of subpixels.

According to the present invention, a light emissive display device comprises a plurality of pixels, each having a substantially quadrangular shape and including four subpixels, wherein of the four subpixels, the subpixels adjoining horizontally have the same height, and at least one of the subpixels has an area different area from the other subpixels.

Further, according to the present invention, of the four subpixels, the subpixels adjoining vertically may have the same width.

Further, according to the present invention, the four subpixels may respectively emit red, green, blue, and white light. Further, the order of arrangement of the four subpixels may be the same in each of the plurality of pixels.

According to an aspect of the present invention, in the above light emissive display device, each of the four subpixels includes an electroluminescence element, each the electroluminescence element emitting the same color, and a color filter is provided in at least one subpixel.

According to another aspect of the present invention, in the above light emissive display device, of the four subpixels each assigned a color of a predetermined wavelength component, the subpixel corresponding to the wavelength component with highest light emission intensity in a light emission spectrum of the electroluminescence element has an area smaller than the area of at least one of the subpixels corresponding to other wavelength components.

According to the present invention, a light emissive area of a light emissive element provided in each subpixel may differ among the subpixels having different areas.

According to a further aspect of the present invention, a light emissive display device comprises a plurality of pixels, each having a substantially quadrangular shape and divided into four subpixels by two divisional lines, wherein of the four subpixels, the subpixels adjoining horizontally have the same height in a column direction, the subpixels adjoining vertically have the same width in a row direction, and at least one of the subpixels has a different area from the other subpixels.

Further, according to a further aspect of the present invention, in the above light emissive display device, at least two signal lines for operating each subpixel are provided along a direction in which either or both of the two divisional lines extends.

According to a still further aspect, the present invention provides a pixel layout formation method for a light emissive display device including a plurality of pixels, each having four subpixels, the method comprising setting, in an a virtual one pixel region, an intersecting point of two divisional lines for dividing one pixel region into four; so that at least one of the subpixels has an area different from that of the other subpixels; determining, after such division, whether or not the plurality of pixels are linearly arranged in row and column directions in a display region; and, when the plurality of pixels are not linearly arranged in at least one of the row and column directions, determining whether or not coordinates of the intersecting point of the divisional lines are maintained; when the coordinates are maintained, rotating the subpixels horizontally adjoining in the row direction using the divisional line extending in the column direction as an axis, or rotating the subpixels vertically adjoining in the column direction using the divisional line extending in the row direction as an axis; or, when the coordinates are not maintained, shifting the relative positions of upper and lower rows or positions of right and left columns.

Further, according to another aspect of the present invention, a light emissive display device comprises a plurality of pixels, each having four subpixels, wherein, of the four subpixels, at least one of the height of the horizontally adjoining subpixels and the width of the vertically adjoining subpixels is identical, and the areas of at least one of the subpixels differs from that of the other subpixels.

According to the present invention, because the horizontally adjoining subpixels are provided with the same height, a selection line extending, for example, in the row direction for operating each subpixel can be linearly disposed without meandering, thereby facilitating circuit layout design.

Further, because the vertically adjoining subpixels have the same width, lines extending in the column direction, such as a video signal line and a power source line, can be disposed without meandering. The lines can be linearly disposed perpendicular to the above selection line and the like extending in the row direction, thereby facilitating circuit layout design and achieving a high aperture ratio.

Even when a pixel is formed of four subpixels for four colors of R, G, B, and white (W) provided separately therefrom, the subpixel layout achieving light emission with a high luminance while requiring less amount of current per pixel can easily be designed taking into consideration dependency on the wavelength of emitted light of a light emissive element, dependency on transmission wavelength of a color filter, and the like. Therefore, the area ratio thereof can also be easily changed.

According to the present invention, for any layout, the intersecting point of two divisional lines for dividing one pixel region into four is first set in a virtual one pixel region, and the one pixel region is divided into four subpixel regions so that the area of at least one of the subpixels differs from the areas of the other subpixels. Subsequently, depending on conditions, such as whether or not a plurality of pixels are linearly arranged in the row and column directions in a display region or whether or not the coordinates of the intersecting point of the divisional lines are maintained, selection is made among establishing virtual one pixel and the divisional lines and the intersecting point, rotating the subpixels horizontally adjoining in the row direction with the divisional line extending in the column direction as a basis, rotating the subpixels vertically adjoining in the column direction with the divisional line extending in the row direction as a basis, and relatively shifting the positions of the upper and lower rows or those of the right and left columns. As a result, subpixels can easily be disposed in a variety of layouts in a pixel region which may have any of various shapes and arrangements.

### BRIEF DESCRIPTION OF THE DRAWINGS

FIG. 1 shows a schematic configuration of a display device according to an embodiment of the present invention.

FIG. 2 shows a circuit structure example of a subpixel forming one pixel of the display device according to the embodiment of the present invention.

FIG. 3A, FIG. 3B, FIG. 3C and FIG. 3D are views for describing example layouts of four subpixels forming one pixel.

FIG. 4 shows a layout example of a pixel of the display device according to the embodiment of the present invention.

FIG. 5 shows a spectrum example of emitted light obtained by an organic EL element emitting white light.

FIG. 6 schematically shows a cross sectional configuration taken along the line X-X in FIG. 4.

FIG. 7A, FIG. 7B, FIG. 7C, FIG. 7D, FIG. 7E, and FIG. 7F show examples of rotation and shifting of the subpixel positions after the setting the intersecting point.

FIG. 8 is a flowchart showing an example of a pixel layout designing procedure according to the embodiment of the present invention.

FIG. 9 shows an example of a system configuration for implementing the procedure shown in FIG. 8.

### DESCRIPTION OF THE PREFERRED EMBODIMENT

A best mode to practice the present invention (hereinafter referred to as an embodiment) will now be described with reference to the accompanying drawings.

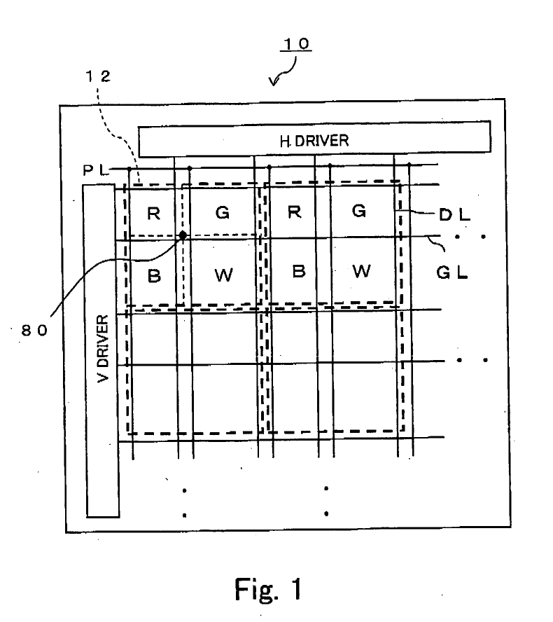

FIG. 1 shows a concept of arranging pixels 12 in a light emissive display device 10 according to an embodiment of the present invention. The display device 10 includes a plurality of substantially quadrangular (the area surrounded by a thick broken line in FIG. 1) pixels 12 arranged in a matrix at a display portion on a substrate. Each pixel 12 includes four subpixels of R, G, B, and W, emitting different colors of light. By thus combining the W subpixel to the R, G, and B subpixels to form a single pixel, an image with a higher white component, such as an outdoor landscape, can be displayed using less power.

According to the present embodiment, a checkerboard arrangement of 2 rows by 2 columns is employed for arranging the four subpixels of the pixel 12. While the R, G, B, and W subpixels may be arranged in any order in a single pixel, in the example of FIG. 1, the subpixel emitting R light is arranged in the first row and the first column, the subpixel emitting G light is in the first row and the second column, the subpixel emitting B light is in the second row and the first column, and the subpixel emitting W light is in the second row and the second column.

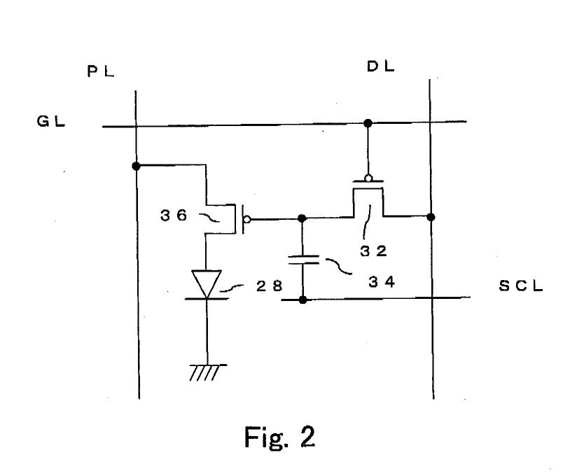

It should be noted that the term subpixel refers to the smallest light emission unit which emits light at an intensity in accordance with a data signal. Light emission from each subpixel is obtained at a light emissive element, and an organic EL element is provided as the light emissive element in the present embodiment. Further, each subpixel includes a thin film transistor (TFT), though not shown in FIG. 1, for individually controlling the organic EL element of the subpixel, as illustrated in FIG. 2 described hereinafter.

In the example shown in FIG. 1, a peripheral driving circuit (an H driver and a V driver) for driving each pixel is provided in a peripheral region of the display portion where such a plurality of pixels are arranged, i.e. in a peripheral region of the substrate. Such a peripheral driving circuit can use a plurality of TFTs formed at the same time through substantially the same process as the TFT for each subpixel.

A wiring line for driving each of the subpixels arranged in two rows and two columns is connected to the peripheral driving circuit (which may not be a built-in type, and may be externally connected). In the direction of each row, a selection line for selecting a subpixel (row) to which display data should be written, or, more specifically, a selection line (gate line) GL for receiving a selection signal to turn on a TFT of a corresponding subpixel, is arranged. In the direction of each column, a data line DL for supplying display data in accordance with displayed content to the selected subpixel, and a power source line PL for supplying driving current in accordance with display data to the EL element of each subpixel are arranged.

According to the present embodiment, the subpixels horizontally adjoining in the row direction in each pixel 12 are set to have an equal height (row pitch). In the column direction, the vertically adjoining subpixels are set to have an equal width (column pitch).

Therefore, in one pixel, one gate line GL can be disposed in a linear manner corresponding to the two subpixels adjoining in the same row direction (horizontal scanning direction), and the data line DL and the power source line PL can be disposed in a linear manner in the column direction corresponding to the two subpixels adjoining in the same column direction (vertical scanning direction), as shown in FIG. 1.

The adjoining pixels themselves are also arranged in a linear manner in the row and column directions, so that the subpixels in the first row, and the second row, of the pixels arranged side by side in the row direction are respectively disposed in a linear manner, and that the subpixels in the first column, and the second column, of the pixels arranged side by side in the column direction are also respectively disposed in a linear manner. Thus, the subpixels of all the pixels can be orderly arranged in a matrix in the row and column directions according to the present embodiment.

It should be noted that it is desirable that the area of each subpixel for R, G, B, or W in a single pixel be properly sized in accordance with a variety of requirements, such as light emission efficiency of the organic EL element, intensity distribution in the spectrum of emitted light (especially for light of additive color), transmission properties of a color filter, and the use of the display device, as described above. As a result, the area ratio of the subpixels in a single pixel must sometimes be varied.

According to the present embodiment, the area and area ratio of the subpixels in one pixel are determined by the position (coordinates) of an intersecting point 80 of two divisional lines dividing one pixel into four subpixels. One of the two divisional lines extends in the row direction similarly to the gate line GL, the other line extends in the column direction similarly to the data line DL and the power source line PL, and the two lines cross at right angles at the intersecting point 80. It should be noted that the illustrated divisional lines do not exist in actual devices, but are used as virtual lines for design.

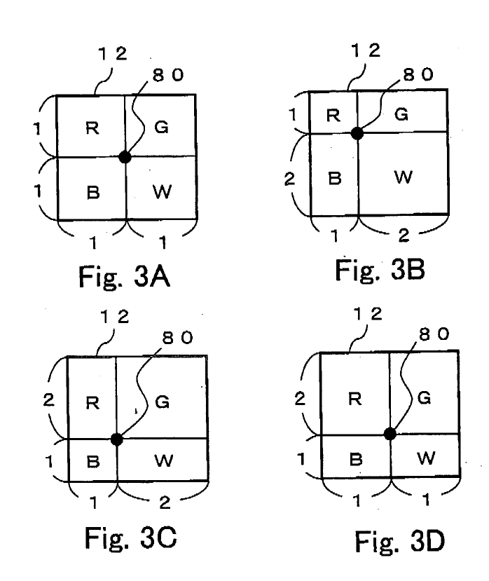

The intersecting point 80 in the example of FIG. 1 is shifted from the center of the substantially quadrangular pixel, thereby allocating the smallest area to the R subpixel, the largest area to the W subpixel, and the intermediate equal areas to the G and B subpixels. As described hereinafter in connection with FIG. 3, when a different area ratio is desired, by shifting the position of the intersecting point 80, the area ratio and the layout and shape of the subpixels can be determined automatically.

The plurality of pixels provided in the same display device are most commonly designed to have the same subpixel area ratio, and therefore the relative position of the intersecting point in each pixel is the same. As a result, even when the intersecting point 80 is not positioned at the center of the pixel as shown in FIG. 1, the two subpixels adjoining in the row direction and the two subpixels adjoining in the column direction can each be disposed in a linear manner. Therefore, even though the subpixel pitch, i.e. row pitch or column pitch, is varied for each row or column, all the subpixels can be orderly arranged in a matrix. As described above, according to the present embodiment, the ratio of areas of the respective subpixels can easily be modified by changing the position of the intersecting point 80 of the subpixels in two rows and two columns, thereby facilitating layout designing of the pixel.

Further, according to the present embodiment, the data line DL and the power source line PL are shared by two subpixels vertically adjoining in a pixel, thereby reducing the area occupied by wiring, and achieving a higher aperture ratio, as compared with a configuration where the lines DL and PL are disposed for each of the subpixels for different colors.

An example of a circuit configuration of a single subpixel in the display device 10 according to the present embodiment will next be described with reference to FIG. 2. In the example shown in FIG. 2, one subpixel includes an EL element 28 emitting light when current is supplied, a selection TFT 32 controlled on and off by a selection signal and supplying a voltage in accordance with a data signal applied to the data line DL to a storage capacitor 34 and a driving TFT 36, the storage capacitor 34 for storing the voltage in accordance with the data signal, and the driving TFT 36 for controlling driving current supplied from the power source line PL to the EL element 30 in accordance with the voltage stored in the storage capacitor 34.

The selection TFT 32 is a p-channel TFT in this example having a gate connected to the gate line GL, a source connected to the data line DL, and a drain connected to a gate of the driving TFT 36. The driving TFT 36 is a p-channel TFT in this example having a source connected to the power source line PL, and a drain connected to an anode of the EL element 28. A cathode of the EL element 28 is connected to a predetermined negative power source or ground. A first electrode of the storage capacitor 34 is provided between the drain of the selection TFT 32 and the gate of the driving TFT 36. More specifically, the first electrode of the storage capacitor 34 is connected to the drain of the selection TFT 32 and the gate of the driving TFT 36, and a second electrode thereof is connected to a storage capacitor line SCL. (In practice, the storage capacitor line SCL is also used as the second electrode.)

When a low (L) level selection signal is output to a predetermined gate line GL, the selection TFT 32 of the subpixel connected to that gate line GL is turned on. The subpixel data (display data) of a corresponding column is sequentially or collectively set at the data line DL in each column, thereby setting a voltage of display data at the gate of the driving TFT 36. This voltage is stored in the storage capacitor 34, and the gate voltage of the driving TFT 36 is maintained at the voltage in accordance with the display data for a predetermined period (such as one vertical scanning period until the corresponding row is reselected). The driving TFT 36 continues operation for the predetermined period in accordance with the above gate voltage, so that current in accordance with the above gate voltage is supplied from the power source line PL through the driving TFT 36 to the EL element 28, which emits light at an intensity corresponding to the supplied amount of current.

The layout of the four subpixels in a single pixel will be further described with reference to FIG. 3. A pixel has a substantially quadrangular shape, and divided into four subpixels of R, G, B, and W by two divisional lines extending in row and column directions. The intersecting point 80 of the divisional lines is a vertex shared by the four substantially quadrangular subpixels of R, G, B, and W.

A height “h” of a subpixel (in the column direction, i.e. the length in the vertical scanning direction) is defined here as the distance between the gate line GL supplying the selection signal to the subpixel in a certain row and a portion immediately before the gate line GL supplying the selection signal to the subpixel in the next row. A width “w” of the subpixel (in the row direction, i.e. the length in the horizontal scanning direction) is defined here as the distance between the power source line PL supplying driving current to the subpixel in a certain column and a portion immediately before the power source line PL supplying driving current to the subpixel in the next column. The subpixel area S will here be assumed to be: S=h×w, although it should be noted that in actual devices it is often the case that the pixels and subpixels are not completely quadrangular in shape, due to layout reasons, and that the area therefore may not be equal to h×w.

As described above, according to the present invention, the height “h” of each of the subpixels adjoining in the row (horizontal) direction in a single pixel is equal to each other, and the width “w” of each of the subpixels adjoining in the column (vertical) direction in a single pixel is also equal to each other, so that the area ratio (or the areas) of the four subpixels can be uniquely determined by designating the coordinates of the intersecting point 80 in the pixel 12 region. FIGS. 3A-3D show examples in which such a layout method utilizing the setting of the intersecting point 80 is employed to vary the area ratio of the four subpixels by changing the coordinates of the intersecting point 80 of the divisional lines in a single pixel. In FIGS. 3A-3D, each pixel has an identical, substantially square shape, and the arrangement order of the four subpixels of R, G, B, and W divided by two divisional lines in the pixel is the same; more specifically, the R subpixel is arranged in the first row and the first column, the G subpixel is in the first low and the second column, the B subpixel is in the second row and the first column, and the W subpixel is in the second row and the second column. The area ratio of the subpixels differs in each example. Naturally, the arrangement order in a pixel is not limited to the above-mentioned example, and the relative positions between the R, G, B, and W subpixels may be switched with each other in the vertical row direction, horizontal column direction, or diagonal direction.

The example layout shown in FIG. 3A is similar to the layout in FIG. 1, and the position of the intersecting point 80 of the divisional lines is set at the center of the pixel 12. Therefore, the ratio of the areas S of the four subpixels of R, G, B, and W is 1:1:1:1. In such a case, regarding pairs of the horizontally adjoining subpixels, the ratio of the height “h” of the R and G subpixels in the first row to the height “h” of the B and W subpixels in the second row is 1:1. Regarding pairs the vertically adjoining subpixels, the width “w” of the R and B subpixels in the first column to the width “w” of the G and W subpixels in the second column is 1:1.

In the example layout shown in FIG. 3B, the coordinates of the intersecting point 80 of the divisional lines is set so that the ratio of the height “h” of the two subpixels in the first row to the height “h” of the two subpixels in the second row is 1:2, and that the ratio of the width “w” of the two subpixels in the first column to the width “w” of the G and W subpixels in the second column is 1:2. In such a layout, the ratio of the areas S of the four subpixels of R, G, B, and W is 1:2:2:4.

In the example layout shown in FIG. 3C, the coordinates of the intersecting point 80 of the divisional lines is set so that the ratio of the height “h” of the subpixels in the first row to the height “h” of the subpixels in the second row is 2:1, and that the ratio of the width “w” of the two subpixels in the first column to the width “w” of the two subpixels in the second column is 1:2. In such a layout, the ratio of the areas S of the four subpixels of R, G, B, and W is 2:4:1:2.

In the example layout shown in FIG. 3D, the coordinates of the intersecting point 80 of the divisional lines is set so that the ratio of the height “h” of the two subpixels in the first row to the height “h” of the two subpixels in the second row is 2:1, and that the ratio of the width “w” of the two subpixels in the first column to the width “w” of the two subpixels in the second column is 1:1. In such a layout, the ratio of the areas S of the four subpixels of R, G, B, and W is 2:2:1:1.

As illustrated by the examples of FIG. 3, according to the present embodiment, by positioning the intersecting point 80 of the divisional lines dividing a pixel into four subpixels of R, G, B, and W in accordance with a required area ratio of the four subpixels, a desired area ratio can be achieved, and the layout and shape of the subpixels can be determined. In other words, the area ratio and layout of the subpixels can be automatically determined by shifting the position of the intersecting point. Accordingly, the layout of the subpixels need not be designed from the beginning even when the area ratio must be varied, and the layout of the four subpixels with a desired area ratio can easily be determined simply by adjusting one parameter, i.e. the coordinates of the intersecting point of the divisional lines.

Consequently, the area of each subpixel can be changed in an extremely easy manner in accordance with light emission efficiency of the EL element, intensity distribution of emitted light (especially for light of additive color), and optical properties (such as transmission properties) of a color adjusting element, such as a color filter, so that the pixel layout with an optimum area ratio can efficiently be designed.

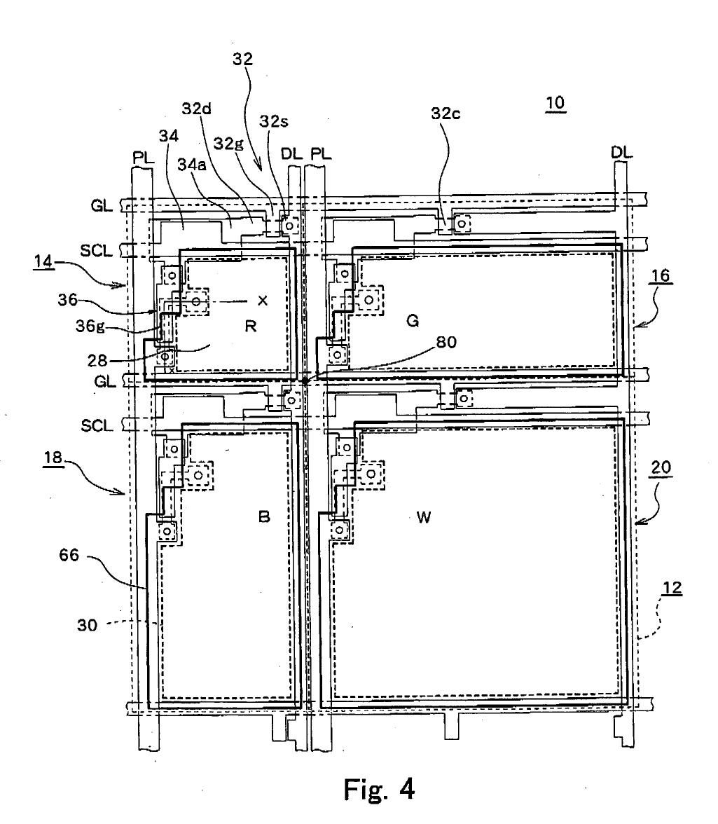

A more specific layout in one pixel will next be described with reference to FIG. 4.

The pixel layout in FIG. 4 relates to an example where a pixel is actually designed so that the arrangement and area ratio of the four subpixels forming the pixel satisfy the relations shown in FIG. 3B. More specifically, FIG. 4 shows a schematic planar configuration per pixel in which the intersecting point 80 is set as in FIG. 3B so that the ratio of the heights “h” of the subpixels in the upper and lower rows is 1:2, and that the ratio of the widths “w” of the subpixels in the left and right columns is 1:2. The subpixel area ratio R:G:B:W equals to 1:2:2:4. Although the divisional lines and the intersecting point thereof are not present in the pixel of actual devices as described above, when the layout of, for example, FIG. 4 is designed, a divisional line in the column direction is set between the data line DL and the power source line PL provided next to each other in the central portion of a pixel, a divisional line in the row direction is set in the center of the gate line GL for the subpixels in the second row, and the intersecting point 80 of these two divisional lines can be used as a criterion for designing the subpixel area ratio and the layout.

Although it is described above that the area S of each subpixel is defined as “h×w”, and that the ratio of such areas S is optimally set as required, the most important region to consider as each subpixel area S in designing a display is the area of a light emissive region 30 of each subpixel (hereinafter referred to as a “light emissive area”). For example, when the light emission efficiency of an organic EL element, especially the external quantum efficiency of the element (the amount of light (the number of photons) actually emitted outside the display with respect to the current supplied to the element (the number of injected electrons)), is smaller in one organic EL element than another, the light emissive area must be increased to enhance the amount of emitted light per subpixel without changing current density. The light emissive region 30 in this embodiment is the region located inside the ends of a first electrode 66 of the organic EL element provided in each subpixel, and it is the region where the first electrode 66 and the light emissive layer directly contact with each other, as described later (details will be described in connection with a more specific configuration of the organic EL element).

According to the present embodiment, circuit elements (the TFTs 32 and 36, the storage capacitor 34, and the wiring lines GL, DL, PL and SCL) to control the organic EL element 28 of the respective subpixels each have substantially the same size and properties even in the subpixels having different areas in order to easily and surely change the subpixel area ratio, and especially the light emissive area of each subpixel, as illustrated in FIG. 4.

More specifically, as shown in FIG. 4, the storage capacitor 34 having the same size for each subpixel is disposed near the intersecting point between the power source line PL and the gate line GL connected to the corresponding subpixel. The selection TFT 32 having the drain and source connected to the storage capacitor 34 and the data line DL is provided, separated from the intersecting point by a distance equal to the length of the storage capacitor 34. The selection TFT 32 (especially its channel) is sized equally for each subpixel, and therefore the distance between the corresponding data line and the selection TFT 32 is varied with the subpixel. The driving TFT 36 is disposed along the power source line PL running in the column direction between the light emissive region 30 and the line PL, and the size (especially its channel) thereof is designed equally for each subpixel. As a result, the distance between the position where the driving TFT 36 and the power source line contact with each other and the corresponding gate line GL is the same for each subpixel, and the distance from the gate line GL in the next row is varied with the height of the subpixel.

With such a layout, the size of the light emissive region of each subpixel is preferentially varied with a change in coordinates of the intersecting point. Further, because the properties of the TFT and the storage capacitor do not change as long as the sizes thereof remain the same, the properties of the circuit elements need not be recalculated. Therefore, the intersecting point can be determined so that the region 30 is sized in accordance with the light emission efficiency of the organic EL element 28 and the required luminance of the element in each subpixel.

An exemplary method of setting the ratio of areas S of the subpixels will next be described. In this example, an organic EL element is used for the light emissive element of each subpixel as described above, and an organic EL element achieving white light by color addition is employed.

The organic EL element emits light of the wavelength in accordance with light emissive material, and exhibits light emission efficiency varied with the material. The subpixel area of the element formed of a material with low light emission efficiency is preferably designed to be larger than the area of the element with high efficiency. Further, when organic EL elements emitting the same color of light, such as white, are used for all subpixels and the color of exiting light is determined by a color filter, the subpixel area is desirably determined taking into consideration the light emission intensity of white light in each wavelength range. As no material directly emitting white light has yet been developed, light of two colors complementary to each other are added to achieve white light. For example, a double-layered light emissive layer composed of a first light emissive layer emitting yellow light (orange in practice) and a second light emissive layer emitting blue light are provided in the organic EL element for this purpose.

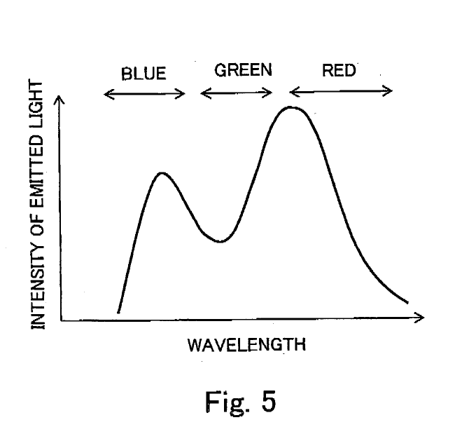

FIG. 5 shows an example spectrum of white light obtained by combining orange and blue light emission as described above. It can be seen from the figure that the light emission intensity of the G wavelength band is the lowest among three primary colors of R, G, and B. Therefore, for white light with such a spectrum, the coordinates of the intersecting point of the divisional lines in a pixel must be determined so that the G subpixel area S_{G} is sufficiently larger than the R subpixel area S_{R} and the B subpixel area S_{B} for R and B light. This is because the light emission luminances of R, G, and B are preferably made as uniform as possible when the same amount of current is supplied to the organic EL element of the respective subpixels in view of improved element life and simplicity in driving the element. When the intensity of emitted light in the R wavelength band is the same as that in the B wavelength band, the R subpixel area S_{R} and the B subpixel area S_{B} can be made equal to each other (both are made smaller than the area S_{G}). Because the intensity of emitted light in the B wavelength band is weaker than that in the R wavelength band in the emitted light spectrum as shown in FIG. 5, the areas satisfying the relation S_{B}>S_{R} is most desirable in order to achieve the uniform driving conditions. The layout of FIG. 4 corresponds to an example desired when the element emitting white light having a spectrum as shown in FIG. 5 is used for each subpixel. Because the R spectrum is the strongest, the areas satisfy the relations S_{R}<S_{G}, and S_{B}<S_{W}. Although the G subpixel area is desirably larger than the B subpixel area strictly considering the spectrum of FIG. 5, problems in visual appreciation are small, and therefore the G and B subpixel areas may be the same in FIG. 4 in view of the white component of the displayed image, easy layout designing, and the like.

Further, the area S_{W} of the white subpixel 20 can be set in consideration of the intended use of the display device or the like. For example, when a white subpixel having the largest area among the four subpixels in FIG. 4 is employed in a display device presenting many outdoor landscape images, reduction in current consumption and improvement in light emission luminance can both be achieved.

The ratio of the areas S of the subpixels is not limited to that shown in FIG. 4, and can be varied as desired in accordance with light emission efficiency of an organic EL element, wavelength of light emitted therefrom, transmission properties of a color filter, properties of displayed images, and the like.

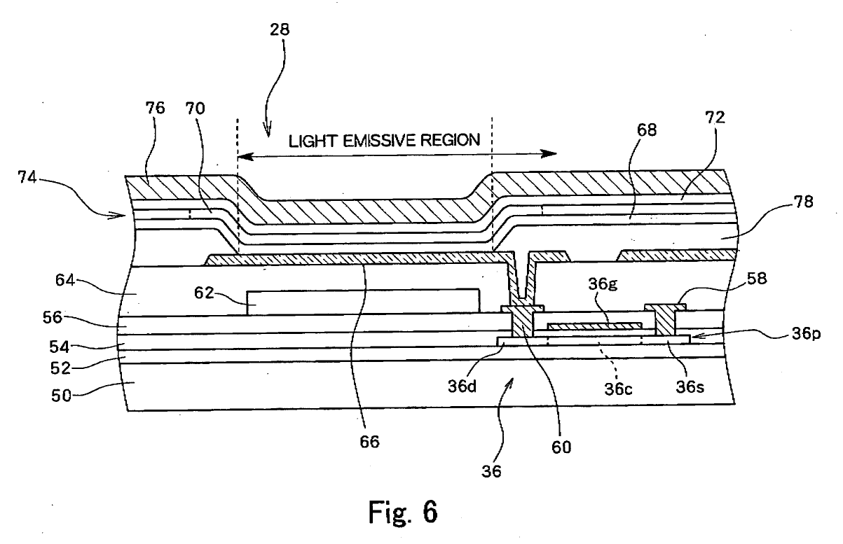

A more specific configuration of each subpixel will next be described with reference to FIG. 4 and FIG. 6. FIG. 4 illustrates a planar configuration of subpixels in a single pixel, as described above, and FIG. 6 illustrates a schematic cross sectional configuration taken along the line X-X in FIG. 4. In the example of FIG. 4, in each of the four subpixels, the selection TFT 32 includes a semiconductor active layer and a gate electrode 32g, which is arranged at a position overlying a channel 32c of the active layer and projects in the column direction from the gate line GL formed in the row direction. A source 32s of the selection TFT 32 is connected to the data line DL at a contact portion.

The storage capacitor 34 includes a capacitor electrode 34a of a semiconductor layer extending in the row direction from a drain region 32d, and the storage capacitor line SCL extending in the row direction as the gate line GL does, disposed to face each other sandwiching a gate insulating film 54 formed in between to cover the semiconductor layer as illustrated in FIG. 6. The capacitor electrode 34a is connected to a gate electrode 36g of the driving TFT 36 through the contact near the power source line PL. The gate electrode 36g is arranged along the power source line PL extending in the column direction. While the gate electrode 36g does not overlap the power source line PL in the arrangement of FIG. 4, part of the gate electrode 36g may underlie the power source line PL. Such an arrangement in which part of the gate electrode 36g is disposed under the power source line PL can increase the aperture ratio utilizing the space under the power source line PL.

The semiconductor layer forming the active layer of the driving TFT 36 extends in the column direction along the power source line PL from the contact portion, provided at a portion projecting toward the inside of the light emissive region 30 from the power source line PL, for contacting the power source line PL, and then bends at a right angle toward the inside of the subpixel away from the power source line PL, forming an L shape or an inverted L shape. The semiconductor layer is connected to an anode (indicated by a thick line in FIG. 4) of the EL element 28 formed above the semiconductor layer through a contact at an end of the above-described portion bended at a right angle.

In this example, the driving TFT 36 is a p-channel transistor, a region of the active layer of the driving TFT 36 connecting to the power source line PL functions as a source, and a region thereof connecting to the anode of the EL element 28 functions as a drain. The gate electrode 36g is formed covering the portion above the channel region located between the source and the drain of the semiconductor layer and having no impurities doped thereto.

Because the contact between the driving TFT 36 and the EL element 28 is located inside the light emissive region 30, the gate electrode 36g can extend in a linear manner along the power source line PL from the contact portion contacting the capacitor electrode 34a in the column direction, thereby preventing a decrease in aperture ratio as is associated with an attempt to detour around the contact portion.

A cross sectional configuration of a subpixel will be described below taking as an example cross sections of the above driving TFT 36 and the organic EL element 28.

On a glass substrate 50, a buffer layer 52 composed of stacked layers of SiN and SiO₂ is formed over the entire surface, and a polysilicon semiconductor layer (active layer) 36p is formed at a predetermined area thereon (an area for forming the TFT) The unillustrated selection TFT 32 includes a cross sectional configuration similar to that of the driving TFT 36. The active layers of the selection TFT 32 and the storage capacitor electrode 34a are each formed of a polysilicon semiconductor layer formed simultaneously with the above polysilicon semiconductor layer 36p of the driving TFT 36.

The gate insulating film 54 is formed over the entire surface covering the active layer 36p and the buffer layer 52. The gate insulating film 54 is formed by stacking layers of, for example, SiO₂ and SiN. The gate electrode 36g of, for example, Cr, is formed over the channel region 36c on the gate insulating film 54. Using the gate electrode 36g as a mask, impurities are doped to the active layer 36p, thereby forming in the active layer 36p a channel region 36c to which no impurities are doped at a central portion under the gate electrode, and the source and drain regions 36s and 36d, respectively, located on both sides of the channel region and having impurities doped thereto.

An interlayer insulating film 56 is formed over the entire surface covering the gate insulating film 54 and the gate electrode 36g. Contact holes are formed penetrating the interlayer insulating film 56 on the source and drain regions 36s and 36d, and a source electrode 58 and a drain electrode 60 are formed on the interlayer insulating film 56 through these contact holes. The power source line (not shown) is connected to the source electrode 58. While the driving TFT 36 formed as described above is a p-channel TFT in this example, it may be formed as an n-channel TFT.

A color filter 62 transmitting only light with a wavelength predetermined for each of the R, G, and B subpixels is formed on the interlayer insulating film 56 in a region located below the EL light emissive region. The color filter 62 is not disposed in the W subpixel.

A planarization film 64 is formed over the entire surface covering the interlayer insulating film 56 and the color filter 62 A transparent electrode 66 functioning as an anode of the EL element 28 is formed on the planarization film 64. A contact hole is formed in the planarization film 64 over the drain electrode 60 penetrating these elements, and through this contact hole the drain electrode 60 and the transparent electrode 66 are connected to each other.

While an organic film of, for example, acrylic resin is typically used for the interlayer insulating film 56 and the planarization film 64, an inorganic film of TEOS (tetra-ethoxysilane) or the like can also be used. The source electrode 58 and the drain electrode 60 are formed of metal, such as Al, and the transparent electrode (first electrode) 66 is typically formed of ITO.

The organic EL element 28 has a configuration wherein a light emissive element layer 74 is provided between an anode and a cathode. According to the present embodiment, the first electrode (transparent electrode) 66 located in a bottom portion of the element functions as an anode, and a second electrode (metal electrode) 76 located in an upper portion of the element functions as a cathode as described hereinafter. Naturally, the element configuration is not limited to that having a lower anode and an upper cathode.

In the present embodiment, the transparent electrode 66 is formed as an individual pattern for each subpixel as illustrated in FIG. 6, while the metal electrode 76 of, for example, Al functioning as a cathode is formed as a pattern common to all subpixels, facing the transparent electrode 66 with at least the light emissive element layer 74 interposed therebetween.

The light emissive element layer 74 at least has one layer of an organic light emissive material, and in the example shown in FIG. 6 has stacked layers composed of a hole transport layer 68, an organic light emissive layer 70, and an electron transport layer 72 provided over the entire substrate, i.e. in common to all subpixels. The organic light emissive layer 70 in this embodiment has a layered structure including a first light emissive layer emitting orange light, and a second light emissive layer emitting blue light to obtain white light, and can be formed in common to all elements without using an evaporation mask having an opening for each subpixel, similarly to other layers for charge transport. The layer 70 can also be formed as a pattern separate for each element. Particularly when each element is formed to emit light of a single different Color, different light emissive materials are used for different colors of emitted light, and therefore a pattern individually formed for each element is used for the light emissive layer 70 in order to avoid mixture of colors and the like. The pattern individually formed for each element can be sized approximately the same as the transparent electrode 66 as indicated by a broken line in FIG. 6.

An end of the transparent electrode 66 is covered with a planarization film 78. The film 78 limits the portion where the hole transport layer 68 and the transparent electrode 66 directly contact with each other in each subpixel, so that an anode and a cathode face each other sandwiching the light emissive element layer 74, and a portion where the transparent electrode 66 and the light emissive element layer directly contact with each other functions as the light emissive region 30. While the planarization film 78 is also typically formed of an organic film of acrylic resin or the like, it may be formed of an inorganic film of TEOS or the like.

The hole transport layer 68, the organic light emissive layer 70, and the electron transport layer 72 are formed of materials typically used for organic EL elements, and the material of the organic light emissive layer 70 determines the color of emitted light. As described above, a stacked layer structure is used in this embodiment to obtain white light.

In such a configuration, when the driving TFT 36 is turned on in accordance with the set voltage of the gate electrode 36g, current from the power source line PL flows from the transparent electrode 66 toward the metal electrode 76. This current causes light emission in the organic light emissive layer 70, and the light transmits through the transparent electrode 66, the planarization film 64, the color filter 62, the interlayer insulating film 56, the gate insulating film 54, and the glass substrate 50, and exits in the lower direction in FIG. 6 (toward the observation side).

When the EL element 28 is formed over the TFT as illustrated in FIG. 6 and a metal material is used for an upper electrode of the element, light from the element is emitted outside from the substrate 50 side where the TFT is formed. In other words, an EL display device of a so-called bottom emission type is obtained. The present embodiment is also applicable to an EL display device of a so-called top emission type, in which light is emitted outside from the upper electrode side of the element by providing an upper electrode of a light transmission type in the element and a reflection layer or the like under the bottom electrode.

In the above description, a coordinate of an intersecting point between two dividing lines which divide a pixel region having an approximate rectangular shape is set and the subpixel regions separated by the two dividing lines are utilized as the actual subpixels. However, when a delta arrangement in which a plurality of pixels are arranged not in a straight line along the row and column direction, but in an undulated manner is employed as the arrangement of the plurality of pixels, it is difficult to place the wiring lines in a straight form in all locations. In addition, there may be cases in which the shape of the desired pixel may not be approximate rectangle. In these cases, one of right and left columns or one of upper and lower rows may be rotated to right or left direction or upward or downward direction with the dividing lines being axes while maintaining the coordinate of the intersecting point after the coordinate of the intersecting point is set. Alternatively, it is also possible to shift one of right and left columns or one of upper and lower columns along the dividing lines after the coordinate of the intersecting point is set. Alternatively, it is also possible to rotate and shift, along the dividing lines, one of two rows or one of two columns after the coordinate of the intersecting point is set. When the row or column is shifted, the number of intersection which is a common vertex of the four subpixels is no longer maintained at 1, and becomes two vertices each common to two subpixels.

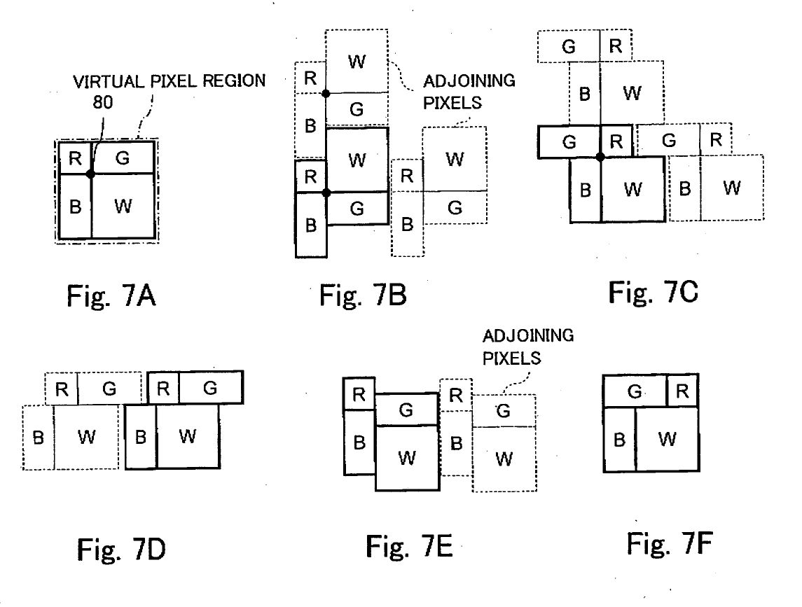

Next, how the rows or columns are partially rotated, partially shifted, or both partially rotated and shifted after the setting of the intersecting point as noted above will be described in detail with reference to the drawings. FIG. 7A is a basic layout identical to FIG. 3B, in which the subpixel areas of R, G, B, and W are set at the ratio of 1:2:2:4 for one pixel region of a substantially quadrangular shape.

By rotating the right column in this layout with the divisional line extending in the row direction as the center, the result is the layout illustrated in FIG. 7B, in which the positions of the G and W subpixels in the right column are vertically switched with each other from those in the basic layout of FIG. 7A, while the positions of the divisional lines and the intersecting point remain unmoved. Because the heights of the subpixels in the upper and lower rows are different from each other in the basic layout as illustrated in FIG. 7A, the resulting one pixel region obtained after vertically inverting the subpixels in one of the two columns as in FIG. 7B does not have an exactly quadrangular shape. However, the condition that the vertically adjoining subpixels have the same width among the four subpixels is satisfied. Because the upper and lower subpixels in one column are switched with each other, the subpixels diagonally opposite to each other across the common vertex (intersecting point) of the four subpixels (the R and G subpixels and the W and B subpixels in this example) have the same height in the example of FIG. 7B.

When the subpixels in the same row are selected by a common gate line as illustrated in FIG. 4, the gate line for the R and w subpixels in the first row must be patterned to bend in the midcourse in accordance with the difference in height between these subpixels. On the other hand, the subpixels arranged in the same column (R and B subpixels and W and G subpixels in this example) each have the same width and therefore the data line and the power source line can be formed in a linear manner in the column direction. By arranging two gate lines side by side for the upper and lower rows along the divisional line extending in the row direction, all the gate lines can be linearly patterned. Design of such a pattern can be facilitated by arranging the TFTs, the storage capacitors, and the EL elements in the respective subpixels to be vertically symmetrical with respect to, for example, the divisional line. When one gate line is provided along the divisional line linearly extending in the row direction, and this single gate line drives the subpixels both in the upper and lower rows, the number of wiring lines in the row direction can be reduced. With such an arrangement, because the selection TFTs in the upper and lower subpixels are simultaneously turned on, display data is preferably supplied from separate data lines to the upper and lower subpixels, and two data lines are preferably provided for each column for this purpose.

FIG. 7C shows a layout in which the upper row in FIG. 7A is rotated using the divisional line extending in the column direction as a basis. Similarly as with the layout in FIG. 7B, the divisional lines and the intersecting point remain unmoved, and the positions of the R and G subpixels in the upper row are horizontally switched with each other from those in the basic layout. Since the horizontally adjoining subpixels have the same height in each row in the layout shown in FIG. 7C, the gate line can be linearly disposed in the row direction. Because the right and left subpixels in one row are switched with each other, the subpixels diagonally opposite to each other across the common vertex (intersecting point) of the four subpixels (the G and W subpixels and the R and B subpixels in this example) have the same width. Because the vertically adjoining subpixels have different widths, at least one of the data line and the power source line must bend at the position where the subpixel width changes. By disposing the power source line along the divisional line extending in the column direction (at the center of one pixel region) to be shared by the horizontally adjoining subpixels, the number of power source lines can be reduced. Only the data line need be disposed outside each pixel region and bended, thereby improving wiring efficiency. It should be noted that the power source line shared by four subpixels should be made thicker in order to maintain the current supply capacity.

FIG. 7D shows a layout in which the upper row in FIG. 7A is shifted rightward after setting the intersecting point, i.e. a layout in which the upper and lower rows are relatively shifted. Because the subpixels horizontally adjoining in the same row have the same height in this layout, the gate line can be linearly formed in the row direction, as in the example of FIG. 7C. FIG. 7E shows a layout in which the right and left columns in FIG. 7A are relatively shifted in a vertical direction after setting the intersecting point. In other words, the two subpixels in the first column (left column) and the subpixels in the second column (right column) are disposed to be shifted in the column direction. In this layout, the pixels vertically adjoining in the same column have the same width, and therefore the data line and the power source line can be linearly formed in the column direction. As described in connection with FIG. 7C, a wide width power source line may be provided along the divisional line in the column direction, so that the power source line can be shared by four subpixels.

FIG. 7F shows an example in which, after setting the intersecting point, the subpixels in the upper row are rotated with the divisional line as an axis to be horizontally switched with each other as in FIG. 7C, and the relative positions of the upper and lower rows are horizontally shifted, thereby achieving a substantially quadrangular outline of one pixel region (it should be noted that the shift amount is not necessarily such an amount that one pixel attains a substantially quadrangular shape) Also in the example of FIG. 7F, the gate line can be linearly disposed in the row direction because the horizontally adjoining subpixels have the same height for each row. While the vertically adjoining subpixels have different widths, the sides of the vertically adjoining subpixels can be aligned at the end of one pixel region, so that at least one of the data line and the power source line provided at this position can be patterned as a straight line.

In any of the layouts shown in FIGS. 7A-7F described above, the area ratio of the subpixels in one pixel region is determined by setting the intersecting point, and at least either the horizontally adjoining subpixels in the same row have the same height or the vertically adjoining subpixels in the same column have the same width. For a stripe arrangement, a layout can be designed in the easiest manner when both of the subpixel height in the same row direction and the subpixel width in the same column direction are each made identical. For a delta arrangement, the subpixels are partially rotated as in FIGS. 7B and 7C, or partially shifted as in FIGS. 7D and 7E, or partially rotated and shifted as in FIG. 7F, in accordance with the required shift amount for the required subpixels having different colors.

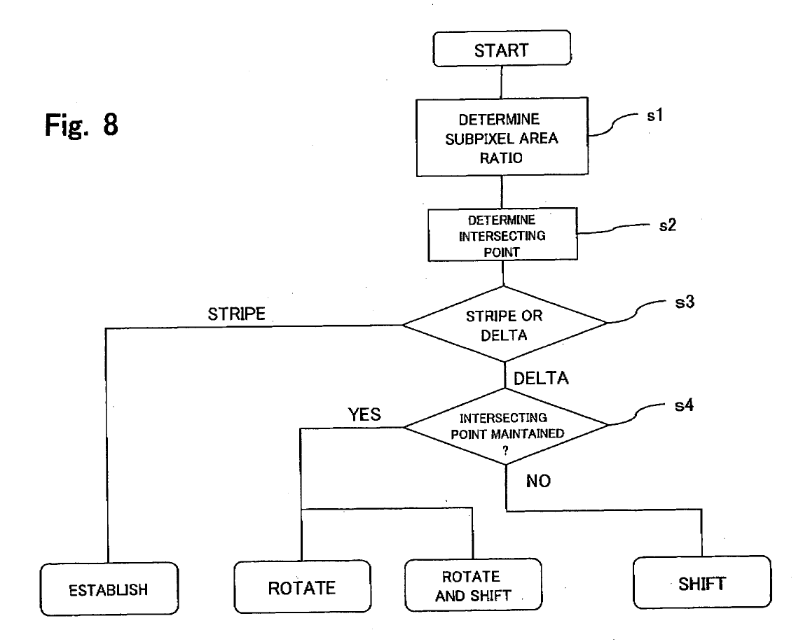

FIG. 8 shows an example of a procedure for designing such a layout. First, the area ratio (the proportion of the respective aperture ratios, to be more specific) of the subpixels forming one pixel is determined (s1), and the coordinates of the intersecting point of the divisional lines dividing virtual one pixel region is determined in accordance with the area ratio (s2). Next, determination is made as to whether the pixel arrangement is a stripe arrangement or a delta arrangement (s3). For a stripe arrangement, a virtual one pixel region and the coordinates of the intersecting point are established to obtain the layout as in FIG. 7A. For a delta arrangement, determination is made as to whether or not the coordinates of the intersecting point are maintained (s4). When the coordinates of the intersecting point are maintained, a layout in which some of the subpixels are horizontally or vertically switched with each other (rotated with respect to the divisional line) as in FIGS. 7B and 7C is obtained. When the coordinates of the intersecting point are not maintained, a shift in the intersecting point will not create any problem, and the positions of the upper and lower rows or those of the right and left columns are relatively shifted as in FIGS. 7D and 7E. When the wiring line is shared, the subpixels may be rotated with respect to the divisional line, and also either the vertical or horizontal positions thereof may be shifted.

At the above step s4, maintaining the intersecting point (and the positions of the divisional lines) at their present coordinates is determined when, for example, the vertically adjoining rows share the gate line, or when the horizontally adjoining columns share the power source line or the data line, as described in connection with FIGS. 7B and 7C, because, to facilitate wiring when the line is shared, it is preferable that the coordinates of the intersecting point and the positions of the divisional lines are not shifted.

The basis for determining whether or not the subpixels are horizontally or vertically switched with each other, and whether or not the relative positions are vertically or horizontally shifted is not limited to whether or not the wiring line is shared as described above, and determination may be made based on the type of delta arrangement, the overall arrangement efficiency, or the like.

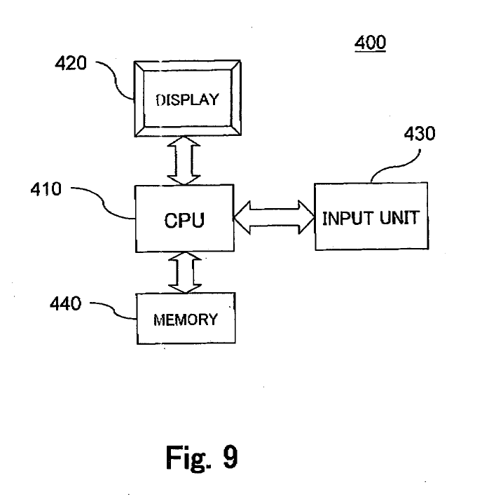

The method of forming a pixel layout as shown in FIG. 8 can easily be implemented by, for example, a system (a computer system) 400 illustrated in FIG. 9. More specifically, in the system 400, a CPU 410 operates an image drawing program, and the coordinates of the intersecting point and the divisional lines are set in a virtual pixel region drawn on a display 420 using an input unit 430, such as a mouse and a keyboard, thereby dividing the virtual pixel region into four subpixels. In accordance with the program, the coordinates of the intersecting point and the like thus set are displayed on the display 420, and the CPU 410 causes a memory 440 to temporarily store the setting. When an operator instructs with the input unit 430 to establish the layout of the divided subpixels or to partially rotate, partially shift, or partially rotate and shift the subpixels as required, the CPU 410 calculates new positions for the subpixels in response to the instruction, and the subpixels with their positions thus changed are displayed on the display 420. When the displayed layout is appropriate, it is stored in the memory 440 or on a hard disk drive (HDD) in accordance with a storage instruction given by the operator.

1. A light emissive display device, comprising
a plurality of pixels, each having a substantially quadrangular shape and including four subpixels, wherein
of the four subpixels, horizontally adjoining subpixels have the same height, and
at least one of the subpixels has an area different from that of the other subpixels.

2. A light emissive display device according to claim 1, wherein
of the four subpixels, vertically adjoining subpixels have the same width.

3. A light emissive display device according to claim 1, wherein
the four subpixels respectively emit red, green, blue, and white light.

4. A light emissive display device according to claim 1, wherein
the four subpixels are arranged in a same order in each of the plurality of pixels.

5. A light emissive display device according to claim 4, wherein
in each of the plurality of pixels, the four subpixels are arranged in a matrix of two rows and two columns.

6. A light emissive display device according to claim 1, wherein
each of the four subpixels includes an electroluminescence element, each the electroluminescence element emitting the same color, and a color filter is provided in at least one subpixel.

7. A light emissive display device according to claim 6, wherein
of the four subpixels each assigned a color of a predetermined wavelength component, the subpixel corresponding to the wavelength component with highest light emission intensity in a light emission spectrum of the electroluminescence element has an area smaller than the area of at least one of the subpixels corresponding to the other wavelength components.

8. A light emissive display device according to claim 1, wherein
of the four subpixels, the subpixel emitting light at highest intensity to outside from a light emissive element provided in each subpixel has an area smaller than the area of at least one of the subpixels corresponding to the other wavelength components.

9. A light emissive display device according to claim 1, wherein
a light emissive area of a light emissive element provided in each subpixel differs among the subpixels having areas different from each other.

10. A light emissive display device, comprising
a plurality of pixels, each having a substantially quadrangular shape and divided into four subpixels by two divisional lines, wherein
of the four subpixels, horizontally adjoining subpixels have the same height in a column direction, and vertically adjoining subpixels have the same width in a row direction, and
at least one of the subpixels has an area different from that of the other subpixels.

11. A light emissive display device according to claim 10, wherein
at least two signal lines for operating each subpixel are provided along a direction in which one or both of the two divisional lines extends.

12. A pixel designing method for a light emissive display device including a plurality of pixels, each having four subpixels, comprising
setting, in a virtual one pixel region, an intersecting point of two divisional lines for dividing one pixel region into four subpixel regions, so that at least one of the subpixels has an area different from the area of the other subpixels;
after such division, determining whether or not the plurality of pixels are linearly arranged in row and column directions in a display region; and
when it is determined the plurality of pixels are not linearly arranged in at least one of the row and column directions, determining whether or not coordinates of the intersecting point of the divisional lines are maintained; and
when it is determined the coordinates are maintained, rotating the subpixels horizontally adjoining in the row direction using the divisional line extending in the column direction as an axis, or rotating the subpixels vertically adjoining in the column direction using the divisional line extending in the row direction as an axis; or
when it is determined the coordinates are not maintained, shifting the positions of upper and lower rows or positions of right and left columns relative to each other.

13. A light emissive display device, comprising
a plurality of pixels, each having four subpixels, wherein
of the tour subpixels, the subpixels adjoining horizontally have the same height, and
at least one of the subpixels has an area different from the area of the other subpixels.

14. A light emissive display device according to claim 13, wherein
the subpixels located opposite each other across a vertex shared by the four subpixels have the same width.

15. A light emissive display device according to claim 13, wherein
the four subpixels are arranged in a matrix of two rows and two columns, and
two subpixels in a first row and two subpixels in a second row are arranged to be shifted in a row direction.

16. A light emissive display device comprising a plurality of pixels, wherein
each of the plurality of pixels has four subpixels,
of the four subpixels, the subpixels adjoining vertically have the same width, and
at least one of the subpixels has an area different from the area of the other subpixels.

17. A light emissive display device according to claim 16, wherein
the subpixels located opposite each other across a vertex shared by the four subpixels have the same height.

18. A light emissive display device according to claim 16, wherein
the four subpixels are arranged in a matrix of two rows and two columns, and
two subpixels in a first column and two subpixels in a second column are arranged to be shifted in a column direction.
